(19) United States
(12) Patent Application Publication
(10) Pub. No.: US 2024/0029482 A1
(43) Pub. Date: Jan. 25, 2024

(54) MODEL EVALUATION AND ENHANCED USER INTERFACE FOR ANALYZING MACHINE LEARNING MODELS

(71) Applicant: Tesla, Inc., Austin, TX (US)

(72) Inventors: John Emmons, Austin, TX (US); Avi Verma, Austin, TX (US); Tim Zaman, Austin, TX (US); Ivan Gozali, Austin, TX (US)

(21) Appl. No.: 18/355,721

(22) Filed: Jul. 20, 2023

Related U.S. Application Data
(60) Provisional application No. 63/368,915, filed on Jul. 20, 2022.

(51) Int. Cl. G07C 5/06; G06N 3/091

(52) U.S. Cl. CPC G07C 5/06; G06N 3/091

(57) ABSTRACT

Systems and methods for model evaluation and enhanced user interface for analyzing machine learning models. An example method includes obtaining information associated with a machine learning (ML) model, wherein the ML model is associated with autonomous or semi-autonomous operation of a vehicle; obtaining validation data, wherein the validation data includes one or more video sequences obtained from image sensors of an end-user vehicle; obtaining output via computing forward pass-through ML model using validation data, wherein the output indicates, at least, location information associated with objects detected via the ML model in the validation data; determining values associated with metrics based on the obtained output; and generating user interface information based on one or more of the determined values or obtained output.

### CROSS-REFERENCE TO RELATED APPLICATIONS

This application claims priority to U.S. Prov. Patent App. No. 63/368,915 titled “MODEL EVALUATION AND ENHANCED USER INTERFACE FOR ANALYZING MACHINE LEARNING MODELS” and filed on Jul. 20, 2022, the disclosure of which is hereby incorporated herein by reference in its entirety.

### BACKGROUND

### Technical Field

The present disclosure relates to analyzing machine learning models and more particularly, to enhanced evaluation of machine learning models for autonomous or semi-autonomous driving.

### Description of Related Art

Neural networks are relied upon for disparate uses and are increasingly forming the underpinnings of technology. For example, a neural network may be leveraged to perform object classification on an image obtained via a user device (e.g., a smart phone). In this example, the neural network may represent a convolutional neural network which applies convolutional layers, pooling layers, and one or more fully-connected layers to classify objects depicted in the image. As another example, a neural network may be leveraged for translation of text between languages. For this example, the neural network may represent a recurrent-neural network.

Complex neural networks are additionally being used to enable autonomous or semi-autonomous driving functionality for vehicles. For example, an unmanned aerial vehicle may leverage a neural network to, in part, enable autonomous navigation about a real-world area. In this example, the unmanned aerial vehicle may leverage sensors to detect upcoming objects and navigate around the objects.

The above-described neural networks typically require substantial processing resources and time to train. Additionally, once trained a neural network typically requires substantial analysis to ascertain whether the neural network is superior to prior trained neural networks.

### BRIEF DESCRIPTION OF THE DRAWINGS

FIG. 1 is a block diagram illustrating an example autonomous or semi-autonomous vehicle which includes a multitude of image sensors an example processor system.

FIG. 2A is a block diagram of an example model evaluation system generating output data based on a machine learning (ML) model and validation data.

FIG. 2B is a block diagram illustrating detail of the example model evaluation system.

FIG. 3A is an example user interface associated with evaluating an ML model.

FIG. 3B is another example user interface associated with evaluating an ML model.

FIG. 3C is another example user interface associated with evaluating an ML model.

FIG. 3D is another example user interface associated with evaluating an ML model.

FIG. 3E is another example user interface associated with evaluating an ML model.

FIG. 3F is another example user interface associated with evaluating an ML model.

FIG. 3G is another example user interface associated with evaluating an ML model.

FIG. 4 is a flowchart of an example process for generating a user interface to evaluate one or more ML models.

FIG. 5 is a block diagram illustrating an example vehicle which includes the vehicle processor system.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

### Introduction

This disclosure describes techniques to visualize the performance (e.g., accuracy) of different machine learning (ML) models, such as neural networks, while reducing the processing time associated with analyzing the neural networks. As will be described, a system described herein (e.g., the model evaluation system 200) may compute forward passes through trained ML models. These ML models may be associated with autonomous or semi-autonomous operation of a vehicle (e.g., vehicle 100). The output of these forward passes may represent raw output, such as locations of, or other information defining, objects (e.g., locations of cuboids surrounding the objects) which are depicted in images provided as input to the ML models. Based on this raw output, the system may compute a multitude of metrics (e.g., user-definable metrics) and generate visualizations associated with the metrics.

Advantageously, a user may update, or create new, metrics and the system may rapidly compute output, and optionally visualizations, associated with these metrics. For example, the raw output associated with the trained ML models may be stored (e.g., in one or more databases). In this way, ML models may be rapidly analyzed while preserving the ability to, at a future date, create new metrics. As an example, metrics may be continuously refined and/or created. For this example, older trained ML models may be compared to newer ML models using these refined and/or newly created metrics.

In contrast, prior techniques to visualize the performance of ML models relied upon creation of visualizations (e.g., creation of videos, such as rendering animations) which correspond to specific metrics as applied to portions of input (e.g., validation data). For example, a first metric may be created for an ML model which is associated with a portion of input data. In this example, the portion of input data may relate to a sequence of images captured by cameras of a vehicle as it traverses a real-world area. The first metric may relate to an accuracy associated with the ML model classifying objects which are depicted in the sequence of images. In this way, a user may view a visualization which graphically illustrates this accuracy as applied to the portion of input data.

However, and as may be appreciated, there may be an overwhelming number of visualizations which are created. For example, there may be a substantial number of videos created using different portions of input data for the first metric. As another example, each ML model may be associated with a multitude of checkpoints during training. For this example, as the ML model is being trained the values of weights, biases, and so on, at different times may be stored as checkpoints. Thus, each checkpoint may be used as an ML model to compare the extent to which further training has increased, or decreased (e.g., overfit the training data), accuracy of the ML model.

Due to the substantial number of checkpoints, and portions of input data, there may be too many visualizations (e.g., videos) created for actual viewing by users. Additionally, to generate the visualizations, specific metrics need to be defined. This may preclude analyses of an ML model at a later date using newer metrics. For example, in the above-described scheme the visualizations may be stored such that only those visualizations, which graphically illustrate the previous metrics, may be accessed. Indeed, there may be no ability to apply the newer metrics to the ML model.

As will be described, the model evaluation system 200 may allow for efficient creation of visualizations of the effectiveness (e.g., accuracy) of an ML model while preserving flexibility in creation of metrics. For example, an ML model may be selected for analysis by a user or software agent. In this example, specific input data may be obtained (e.g., from a database). As an example, the specific input data may be responsive to a query. An example query may cause identification of input data which depicts certain objects (e.g., bicycles, walls, tunnels) and/or other signals or information (e.g., time of day, certain actions depicted in the input data which are performed by pedestrians and/or vehicles, and so on). In this way, a user may provide a query to, ‘find a bicycle taking evasive action out of a bicycle lane’, and specific input data which is responsive to the query may be identified.

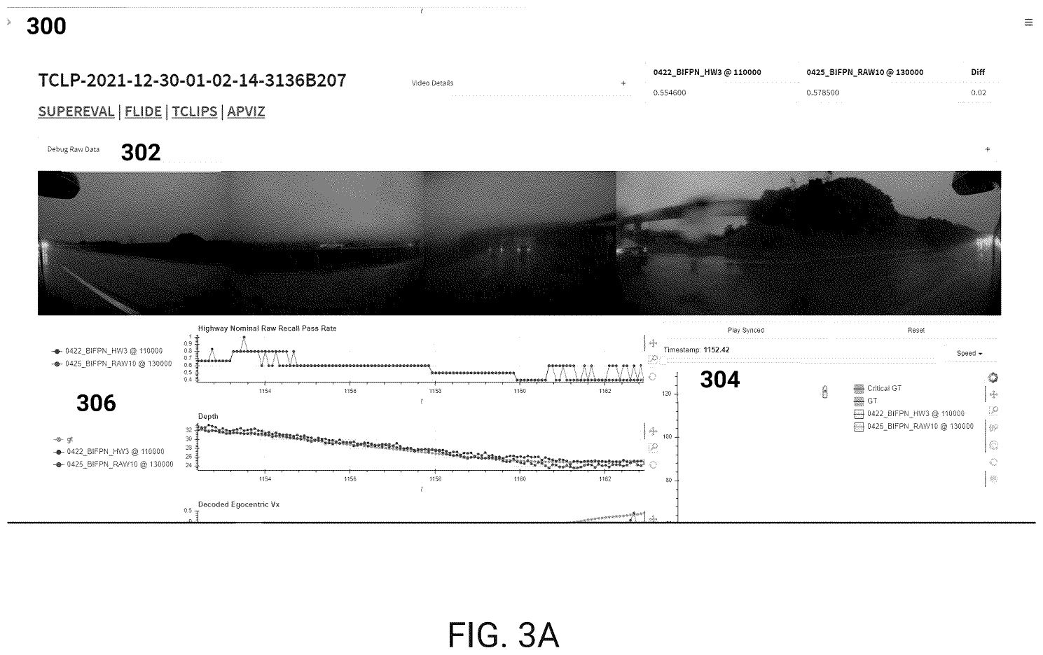

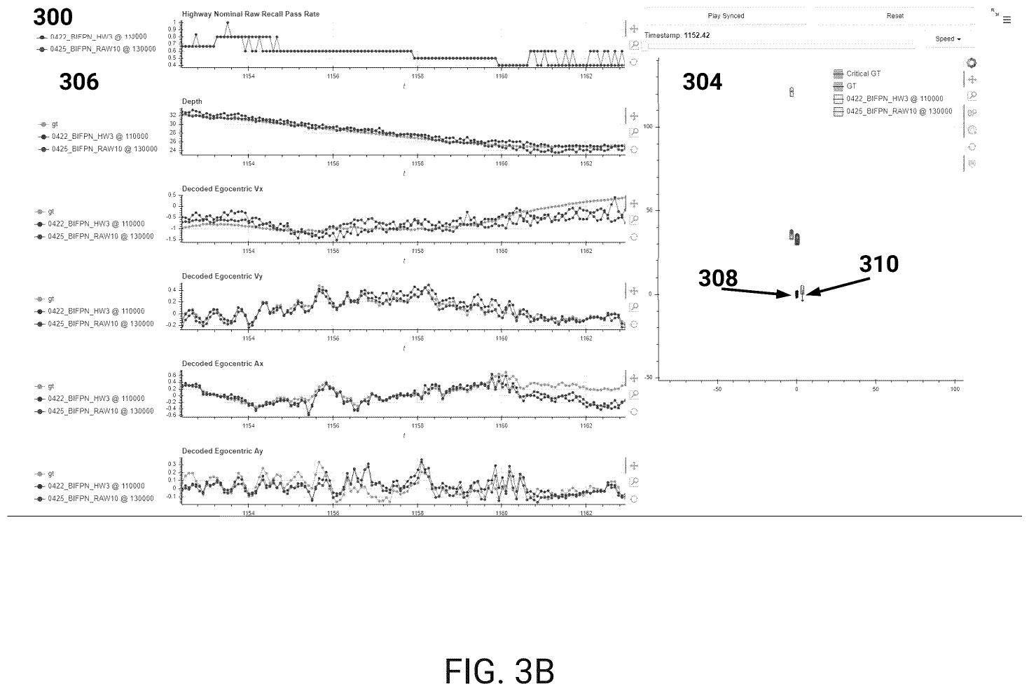

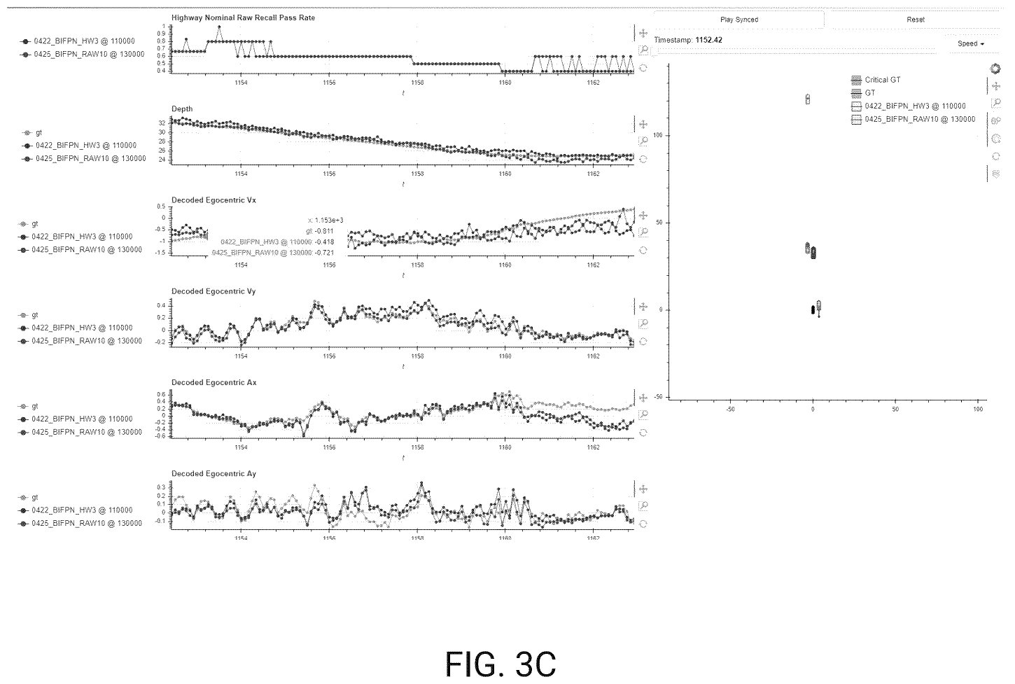

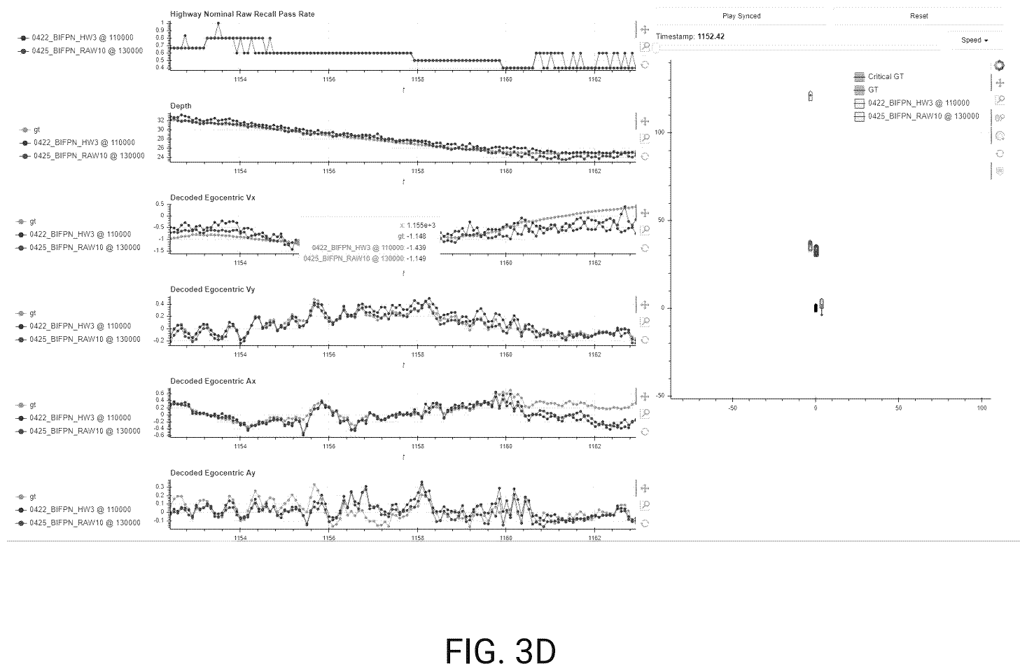

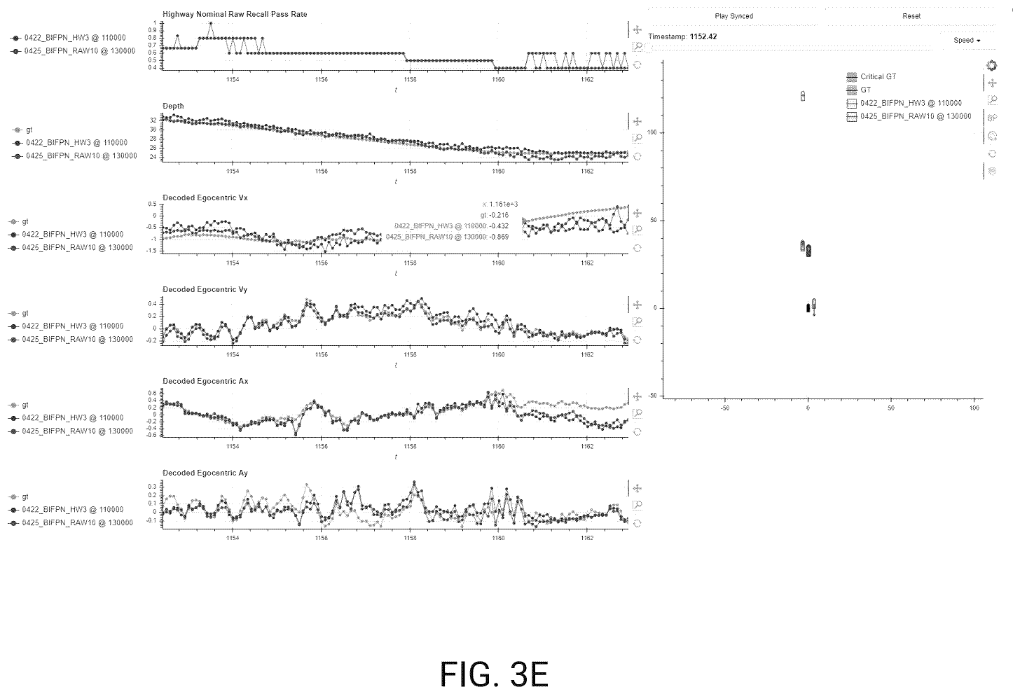

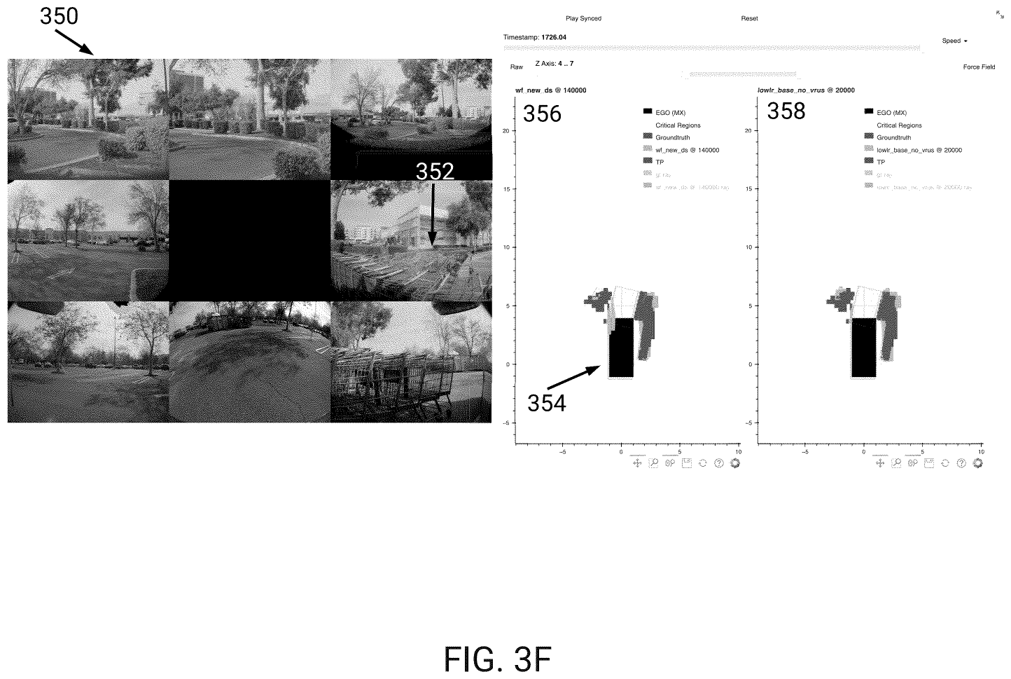

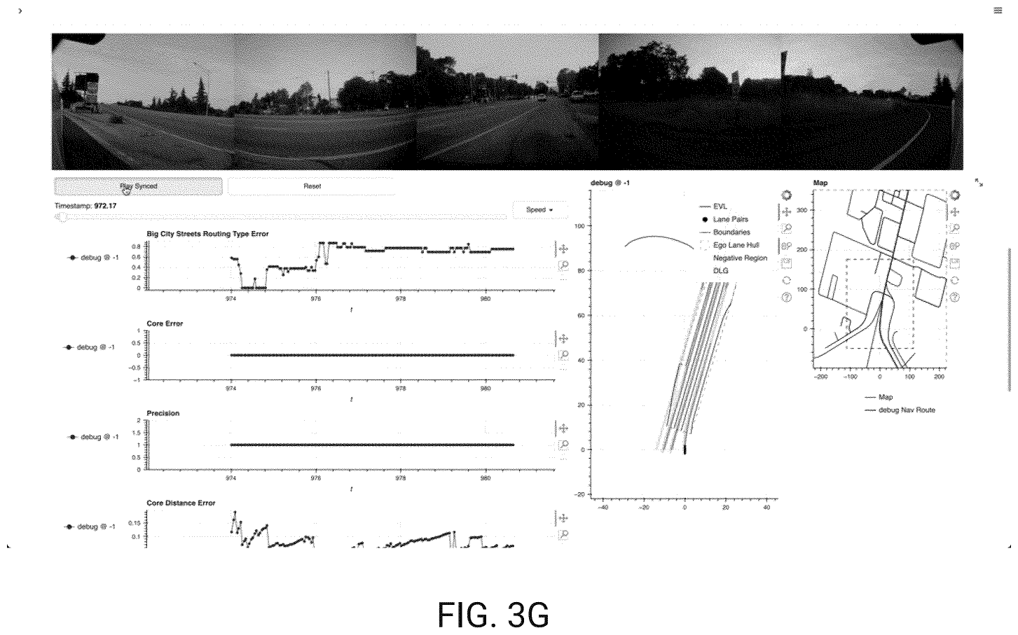

The input data may then be used as input to the ML model and raw output may be obtained by the system 200. For example, the raw output may reflect one or more of locations of objects in the input data, signals (e.g., specific labels associated with actions), and so on. Metrics may then be determined based on the raw output and used to create visualizations. Example visualizations, which are illustrated in FIGS. 3A-3G, may include visualizations of ground truth object locations as compared to object locations in the raw output, graphical representations of metrics, and so on.

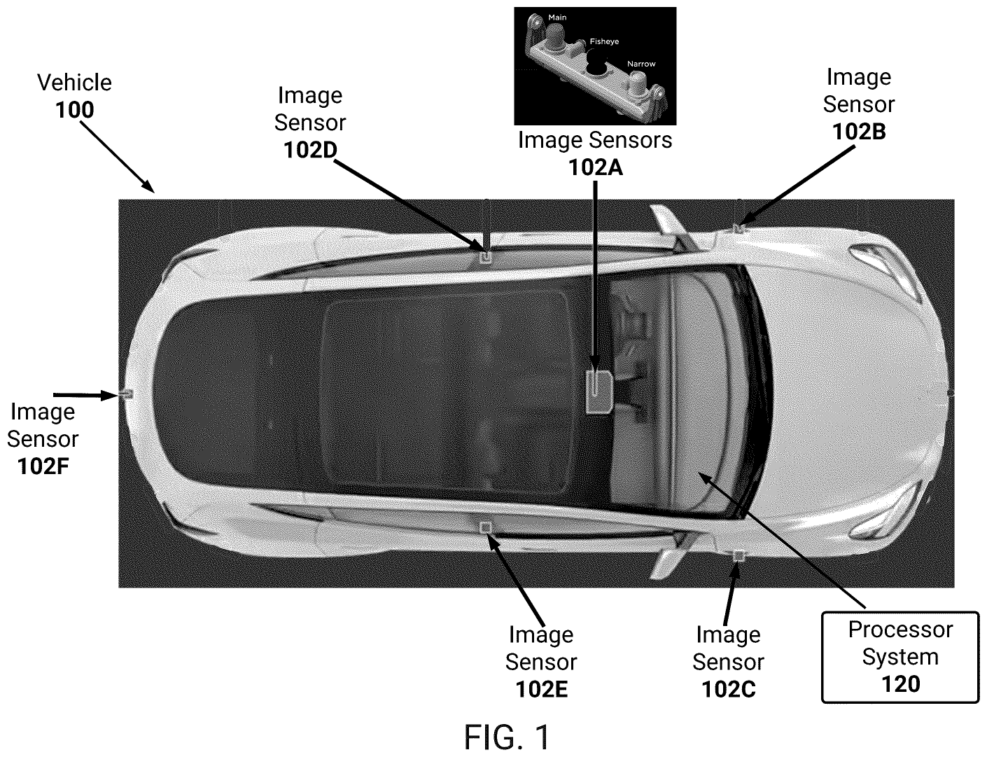

The above and other technical disclosure will now be described with reference to FIGS. 1-5.

### Block Diagram—Vehicle Processing System

FIG. 1 is a block diagram illustrating an example autonomous vehicle 100 which includes a multitude of image sensors 102A-102F an example processor system 120. The image sensors 102A-102F may include cameras which are positioned about the vehicle 100. For example, the cameras may allow for a substantially 360-degree view around the vehicle 100.

The image sensors 102A-102F may obtain images which are used by the processor system 120 to, at least, determine information associated with objects positioned proximate to the vehicle 100. The images may be obtained at a particular frequency, such as 30 Hz, 36 Hz, 60 Hz, 65 Hz, and so on. In some embodiments, certain image sensors may obtain images more rapidly than other image sensors.

Image sensor A 102A may be positioned in a camera housing near the top of the windshield of the vehicle 100. For example, the image sensor A 102A may provide a forward view of a real-world environment in which the vehicle is driving. In the illustrated embodiment, image sensor A 102A includes three image sensors which are laterally offset from each other. For example, the camera housing may include three image sensors which point forward. In this example, a first of the image sensors may have a wide-angled (e.g., fish-eye) lens. A second of the image sensors may have a normal or standard lens (e.g., 35 mm equivalent focal length, 50 mm equivalent, and so on). A third of the image sensors may have a zoom or narrow lens. In this way, three images of varying focal lengths may be obtained in the forward direction by the vehicle 100.

Image sensor B 102B may be rear-facing and positioned on the left side of the vehicle 100. For example, image sensor B 102B may be placed on a portion of the fender of the vehicle 100. Similarly, Image sensor C 102C may be rear-facing and positioned on the right side of the vehicle 100. For example, image sensor C 102C may be placed on a portion of the fender of the vehicle 100.

Image sensor D 102D may be positioned on a door pillar of the vehicle 100 on the left side. This image sensor 102D may, in some embodiments, be angled such that it points downward and, at least in part, forward. In some embodiments, the image sensor 102D may be angled such that it points downward and, at least in part, rearward. Similarly, image sensor E 102E may be positioned on a door pillow of the vehicle 100 on the right side. As described above, image sensor E 102E may be angled such that it points downwards and either forward or rearward in part.

Image sensor F 102F may be positioned such that it points behind the vehicle 100 and obtains images in the rear direction of the vehicle 100 (e.g., assuming the vehicle 100 is moving forward). In some embodiments, image sensor F 102F may be placed above a license plate of the vehicle 100.

While the illustrated embodiments include image sensors 102A-102F, as may be appreciated additional, or fewer, image sensors may be used and fall within the techniques described herein.

The processor system 120 may be obtain images from the image sensors 102A-102F and detect objects, and signals associated with the objects, using the vision-based machine learning model described herein. Based on the objects, the processor system 120 may adjust one or more driving characteristics or features. For example, the processor system 120 may cause the vehicle 100 to turn, slow down, brake, speed up, and so on.

In some embodiments, the processor system 120 may execute one or more machine learning models and/or classifiers which can provide images to an outside server for storage. For example, a classifier may enable identification of specific objects, specific actions performed by objects (e.g., a pedestrian stepping into the road, a truck traveling through a tunnel, and so on), and so on, which are depicted in one or more images. These images may be used by the outside server or system for training and/or validation of machine learning models. For example, and as described below, a system (e.g., the model evaluation system 200) may use specific input data as validation data for trained machine learning models. In this example, the input data may be from the vehicle 100 as it traverses a real-world area.

### Block Diagram—Evaluating ML Models

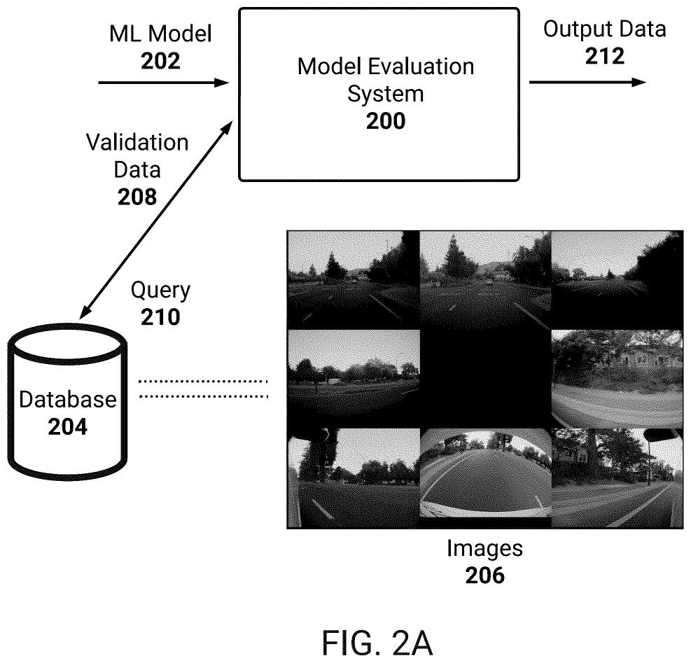

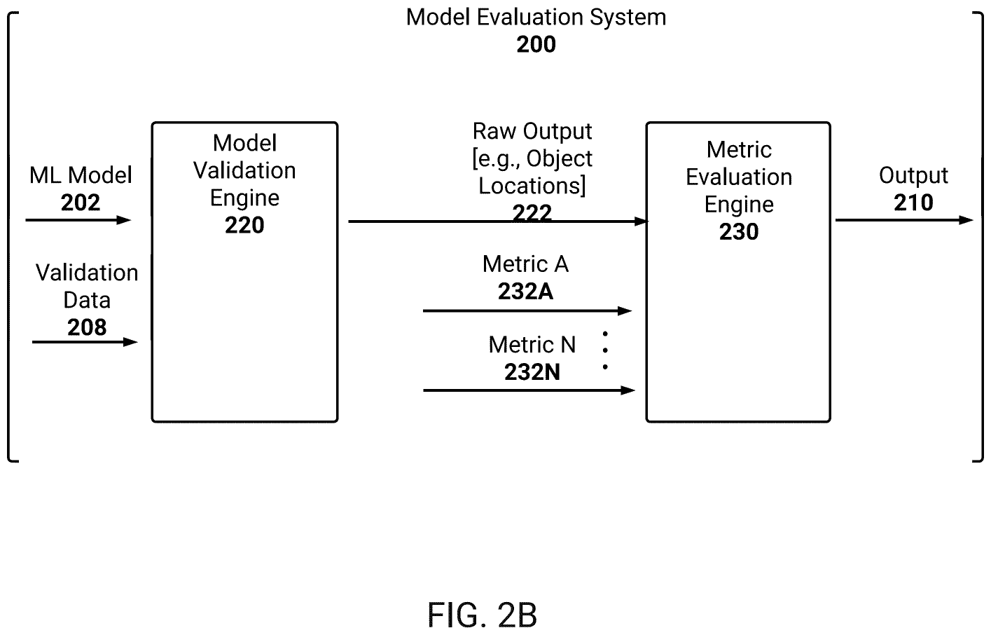

FIG. 2A is a block diagram of an example model evaluation system 200 generating output data 212 based on a machine learning (ML) model 202 and validation data 208. The model evaluation system 200 may represent a system of one or more computers or one or more processors. In some embodiments, the model evaluation system 200 may include specialized processors, such as neural processors or application specific integrated circuits, associated with processing machine learning models. For example, the specialized processors may be designed to efficiently compute forward passes through convolutional layers of a neural network, fully-connected layers of a neural network, attention layers, and so on.

As may be appreciated, an autonomous or semi-autonomous vehicle may require an advanced ML model which is continuously refined, or updated, to enhance the accuracy with which objects positioned about the vehicle may be detected and/or classified. These ML models may require substantial training time using large training data sets. During training, an ML model may have its parameters (e.g., weights, biases, and so on) saved at certain time stamps or checkpoints. Different models, such as models with different hyperparameters/different types of layers (e.g., convolutional, attention, and so on), may be trained each with their own checkpoints. These models may then be analyzed, such as using validation datasets, to ascertain which model, and optionally which checkpoint, is more performant (e.g., lower error).

In FIG. 2A, the model evaluation system 200 is analyzing ML model 202. As described above, ML model 202 may represent a trained ML model which is being analyzed (e.g., by a user or software agent). For example, a user may select the ML model 202 from one or more ML models which are available for testing/validation. The model evaluation system 200 may analyze the ML model 202 based on validation data (e.g., from database 204). While a database 204 is described, as may be appreciated in some embodiments a distributed filesystem may be used.

The validation data 208 may represent images or video clips from vehicles, such as end-user vehicles or training vehicles, which drive about a real-world area. In some embodiments, the validation data 208 may represent simulated data which is rendered to simulate or mimic real-world images. Example images 206 are illustrated in FIG. 2A. The images 206 may represent images obtained by image sensors 102A-102F as described in FIG. 1. For example, the images 206 may depict a substantially 360-degree view of a vehicle which obtained the vehicle. The images 206 illustrated in FIG. 2A may represent images taken at a particular time. As may be appreciated, the validation data 208 may include the images 206 along with images which are prior to, and/or after, the images 206 in time. For example, a video sequence of a threshold amount of time (e.g., 30 seconds, 1 minute, 10 minutes, and so on) may be used as the validation data 208. In this example, the video sequence may include the images 206 as a portion (e.g., a particular set of image frames at a particular time within the video sequence).

In some embodiments, the validation data 208 may be responsive to a query 210. For example, a user and/or software agent may create a query 210 which identifies specific features. In response, the model evaluation system 200 or database 204 may respond with validation data 208 which includes, or is otherwise associated with, the features. For example, the features may indicate specific objects which are of interest. In this example, the query 210 may indicate specific vehicles or vehicle types (e.g., emergency vehicles, trucks, buses, trams, light rail vehicles, bicycles, and so on). The query 210 may also indicate specific objects, such as vulnerable road users (e.g., pedestrians). As another example, the features may indicate specific actions which are depicted. For example, a video sequence may depict a driver side door opening while on the freeway. As another example, a video sequence may depict a rain puddle splashing onto a vehicle which is obtaining a video sequence and blocking one or more of the image sensors (e.g., image sensors 102A-102F). As another example, the features may indicate specific real-world conditions, such as a time of day, specific weather, whether sun glare is affecting the front image sensors, and so on.

The validation data 2008 may be associated with ground truth information. For example, the ground truth information may be labeled by a human or software agent. Example ground truth information may include specific distances to objects, specific locations of objects (e.g., locations corresponding to cuboids surrounding objects), velocities and/or accelerations of objects, actions or labels (e.g., vehicle door open, biker with bags on side of bike, ladder hanging out of back of truck), and so on. In some embodiments, the ground truth information may be generated, at least in part, by a vehicle which obtained the validation data 208. For example, the vehicle may have image sensors 102A-102F along with other sensors (e.g., one or more emitting sensors). In this example, the emitting sensors may be used, at least in part, to determine ground truth information (e.g., specific distances to objects, specific locations of objects, speeds and/or accelerations of objects, and so on).

In addition to images 206, the validation data 208 may include information obtained from sensors of a vehicle. For example, a speed of the vehicle which obtained the images 206 may be provided in the validation data 208. As another example, an orientation of the vehicle may be provided in the validation data 208. This information may be used, for example, as input when analyzing the ML model 202. For example, the speed of the vehicle may be used to inform relative or actual speeds of other vehicles.

In this way, the model evaluation system 200 may receive the validation data 208 for analysis. The model evaluation system 200 may then compute a forward pass through the ML model 202 using the validation data 208. For example, images which form one or more video sequences (e.g., images 206) may be used as input to the model evaluation system 200 similar to that of images being provided to the processor system 120 included in a vehicle (e.g., vehicle 100). In this example, the images may thus be provided at a particular frame rate (e.g., 30 Hz, 36 Hz, 60 Hz, and so on). For each time stamp at which images are provided according to the particular frame rate, the input may represent a set of images as illustrated in FIG. 2A with respect to images 206. For example, the set of images may include images from image sensors (e.g., image sensors 102A-102F) positioned about a vehicle. Thus, the model evaluation system 200 may simulate how the ML model 202 would respond to validation data 208 similar to how a real-world vehicle executing the ML model 202 would respond to a real-world environment which corresponds to the validation data 208.

Output data 212 may then be generated by the model evaluation system 200 based on the ML model 202 and validation data 208. Example output data 212 may represent information for each set of images included in the validation data 208. For example, location information associated with objects detected in an individual set of images may be included in the output data 212. Additionally, output data 212 may represent signals indicative of one or more of velocities of objects (e.g., relative to ego or absolute velocity), accelerations of objects, distances to objects, object labels or classifications, action labels (e.g., opening of car door, whether a vehicle is parked, which lane a vehicle or vulnerable road user is in, whether a vehicle's blinkers are on, and so on).

Furthermore, output data 212 may represent the output associated with one or more metrics as described in more detail below. These metrics may optionally represent average values across the validation data and/or values for each set of images.

Visualizations, such as those illustrated in FIGS. 3A-3G, may be generated which describe an accuracy or effectiveness associated with the ML model 202. For example, a graphical representation of ego (e.g., a vehicle which obtained the images forming the validation data) may be included in a visualization. Objects which are detected in these images using the ML model 202 may then be included in the visualization. For example, graphical representations of the objects positioned proximate to ego may be included based on the objects' determined locations. In addition, ground truth locations of the objects may be included to visually identify an extent to which the ML model 202 is inaccurate.

FIG. 2B is a block diagram illustrating detail of the example model evaluation system 100. As described above, the model evaluation system 100 may evaluate the ML model 202 using validation data 208. The data 208 may be obtained from one or more video sequences or clips which are obtained from end-user vehicles and/or training vehicles.

The model evaluation system 100 includes a model validation engine which generates raw output 222. As described above, the raw output 222 may include object locations (e.g., for each set of images included in the validation data 208). Example object locations may include information identifying cuboids about objects (e.g., in a vector space or mapped to a real-world space). Example object locations may also include information identifying locations of cuboids. Raw output 222 may additionally include velocities, acceleration, and other signals as described above.

The raw output 222 may optionally be generated for each checkpoint, or a subset of the checkpoints, associated with training the ML model 202. The raw output 222 may then be stored in one or more databases so that the raw output 222, and thus the ML model 202, may be analyzed at a future time to compare it to future trained models. In this way, currently created metrics may be applied to the raw output 222 along with metrics which may turn out to be of interest at a future date.

The model evaluation system 200 additionally includes a metric evaluation engine 230. As illustrated, the raw output 222 may be provided as input to the metric evaluation engine 230 along with one or more metrics 232A-232N (e.g., information defining or otherwise identifying metrics). For example, the metrics 232A-232N may be defined using one or more filters, mathematical or logical operations, and so on which are to be applied to the raw output 222 in view of ground truth information.

An example metric may include an extent to which locations of a particular type of object (e.g., a semi-truck) as determined by the ML model 202 are different as those indicated in the ground truth. Another example metric may include an extent to which a particular action label (e.g., door open on a vehicle proximate to ego) are determined in view of the ground truth. Another example metric may include precision and/or recall using custom/configurable matching criteria (e.g., vulnerable road users and vehicles may have different matching criteria). Another example metric may include L1 or L2 velocity error for associated objects. Another example metric may include accuracy, precision, and/or recall for various attributes (e.g., open vehicle door, blinkers, vehicle semantics, and so on).

The metric evaluation engine 230 may determine output 210 associated with the metrics 232A-232N. For example, particular metrics may be applied across the raw output 222. In this example, the particular metrics may be determined as measures of central tendency for the raw output 222. As another example, particular metrics may be determined for subsets of the raw output 222. For example, a first metric may determine output for a threshold number of sets of images which are included in the validation data 208. As another example, particular metrics may be determined for the raw output 222 which corresponds to an individual set of images which are included in the validation data 208.

Thus, the metric evaluation engine 230 may generate output 210 which may be used to generate visualizations associated with the performance of the ML model 202. Example visualizations are illustrated in FIGS. 3A-3G.

In some embodiments, the model evaluation system 200 may receive two or more ML models. Optionally, the model evaluation system 200 may compare performance of the ML models (e.g., the accuracy of the models or an extent to which error is associated with the models). For example, the same validation data may be used to generate raw output associated with the ML models. Metrics may then be determined for the ML models and used to generate visualizations. An example visualization may depict object locations positioned about ego (e.g., a vehicle which obtained the video sequences which form at least a portion of the validation data 208) as determined the ML models. Another example visualization may depict ground truth object locations, or object locations as determined by the ML models, positioned about ego with colors (e.g., partially transparent colors) extending from the objects. Each color may correspond to one of the ML models and a radius or size of the color about an object may be indicative of an error associated with the ML model's location assignment for the object. Ground truth locations may additionally be included. In this way, a reviewing user can ascertain which ML model more accurately predicts locations of objects. Similarly, distances to objects, speeds of objects, and so on, may graphically illustrated in comparison to the ground truth.

FIG. 3A is an example user interface 300 associated with evaluating an ML model. The example user interface 300 includes a set of images 302 (e.g., obtained from an end-user vehicle or a training vehicle). Similarly, the user interface 300 includes a graphical representation of objects 304 determined by an ML model which are positioned about the end-user vehicle or training vehicle. A reviewing user may select a play, or other, button to cause the set of images 302 to play according to a video sequence as obtained by image sensors positioned on the end-user vehicle or training vehicle. In response, the graphical representation of objects 304 can illustrate movement of the objects in accordance with that seen in the video sequence.

Metric output 306 is additionally included in the user interface 300. For example, a chart (e.g., bar chart) may be included which identifies a value of a metric which varies according to its determination in the video sequence. These metrics may additionally be graphically illustrated in portion 304. For example, a metric may relate to a determination of distance from ego (e.g., the end-user vehicle or training vehicle) to the objects. In this example, an extent to which the determined distance and ground truth distance differ may be graphically illustrated in portion 304.

FIG. 3B is another example user interface 300 associated with evaluating an ML model. As illustrated, portion 304 includes a representation of ego 308 along with a proximate object 310. An arrow is included on the object 310 which points backwards. As an example, the arrow may indicate an error associated with the object's position, speed, distance, acceleration, and so on.

In some embodiments, a reviewing user may select object 310 and view detailed information related to the object 310. For example, the detailed information may include a class of the object as determined by an ML model (e.g., semi-truck, bicycle, and so on) along with a ground truth class. As another example, the detailed information may include location, acceleration, velocity, distance, and so on, which are associated with the object 310 as compared to ground truth information.

FIGS. 3C-3G are additional example user interfaces associated with evaluating an ML model. For example, FIG. 3F illustrates images 350 which represent a view about ego (e.g., a vehicle). These images 350 depict shopping carts 352 which are proximate to the vehicle. On the right-hand portion of the user interface ego 354 is illustrated along with an indication of nearby objects (e.g., the shopping carts 352). Advantageously, a ground truth is included in red along with an indication of a model estimate for the location of the nearby objects.

The user interface includes two models in portion 356, 358 to allow for a quick viewing of these models accuracies. As described above, the images 350 may represent images from a video and a user may select a play, or other, button to watch the video. As the video plays, the location of the objects as compared to ego may be adjusted accordingly.

### Example Flowchart

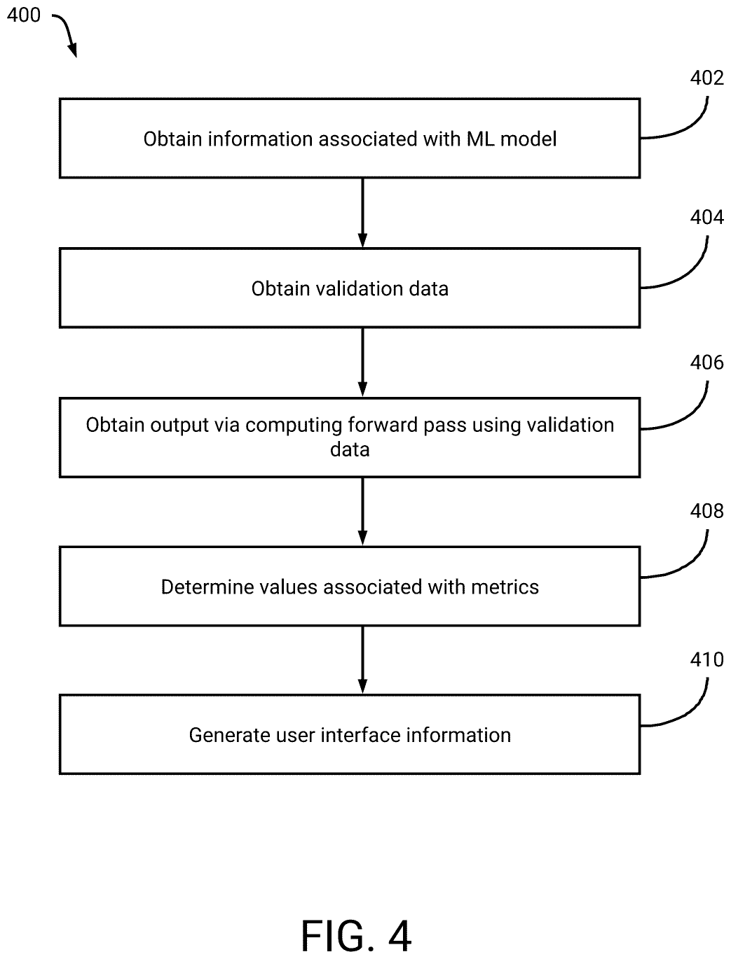

FIG. 4 is a flowchart of an example process 400 for generating a user interface to evaluate one or more ML models associated with autonomous or semi-autonomous operation of a vehicle. For convenience, the process 400 will be described as being performed by a system of one or more computers or processors (e.g., the model evaluation system 200).

At block 402, the system obtains information associated with an ML model. As described above, the system may obtain an ML model for analysis. For example, the system may obtain an ML model definition such as the weights, biases, and so on, which form the ML model along with code associated with its execution.

At block 404, the system obtains validation data. As described above, the system obtains validation data which includes one or more video sequences obtained from end-user vehicles or training vehicles. A user of the system may provide a query to identify specific video sequences which depict particular objects, actions of objects, and so on.

At block 406, the system obtains output based on the ML model. The system computes a forward pass using the validation data to obtain raw output.

At block 408, the system determines values associated with metrics. The system determines output associated with metrics which are defined by a user. Optionally, the user of the system may indicate that the metrics are to be applied to only certain raw output associated with certain video sequences. For example, large validation data sets may be used, and raw output associated with the video sequences. Subsequently, a user may indicate that a metric, such as an existing metric or newly created metric, is to be executed using only a portion of the video sequences. In this way, the user may indicate that the user is to receive output of a metric related to distances to objects using only video sequencies in which a semi-truck takes evasive action.

At block 410, the system generates user interface information 410. The system, or a presentation system which receives output from the system, may cause presentation of a user interface (e.g., on a user device of a user). For example, the user interface may be accessible via a webpage used by a user. Example user interfaces are illustrated in FIGS. 3A-3G.

### Vehicle Block Diagram

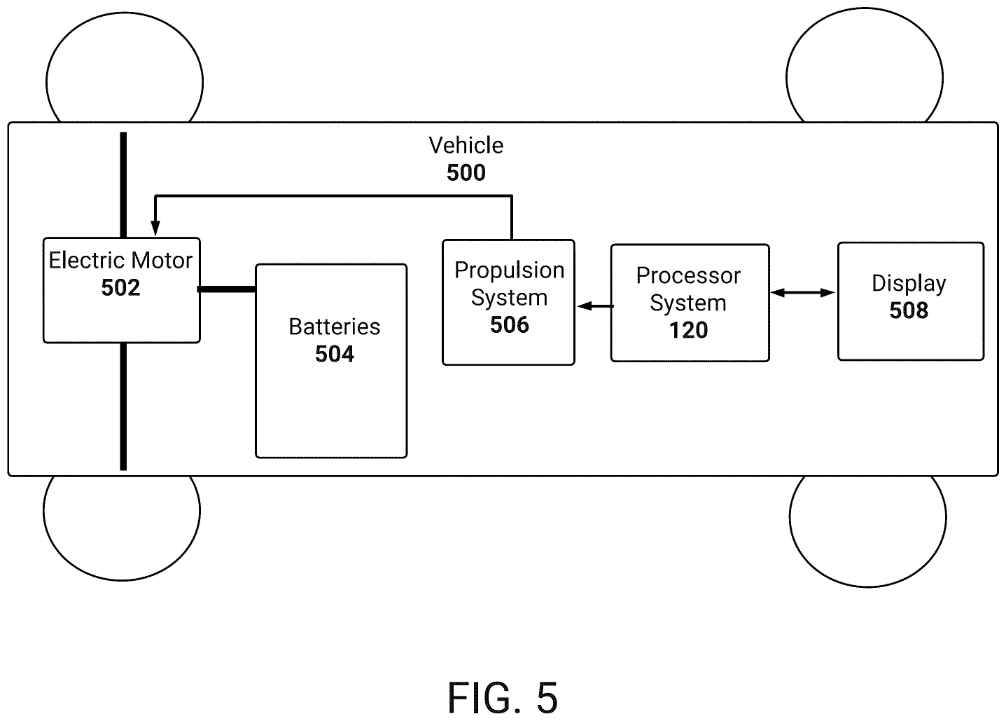

FIG. 5 illustrates a block diagram of a vehicle 500 (e.g., vehicle 100). The vehicle 500 may include one or more electric motors 502 which cause movement of the vehicle 500. The electric motors 502 may include, for example, induction motors, permanent magnet motors, and so on. Batteries 504 (e.g., one or more battery packs each comprising a multitude of batteries) may be used to power the electric motors 502 as is known by those skilled in the art.

The vehicle 500 further includes a propulsion system 506 usable to set a gear (e.g., a propulsion direction) for the vehicle. With respect to an electric vehicle, the propulsion system 506 may adjust operation of the electric motor 502 to change propulsion direction.

Additionally, the vehicle includes the processor system 120 which processes data, such as images received from image sensors 502A-502F positioned about the vehicle 500. The processor system 120 may additionally output information to, and receive information (e.g., user input) from, a display 508 included in the vehicle 500. For example, the display may present graphical depictions of objects positioned about the vehicle 500.

In some embodiments, the processor system 120 may cause images to be provided to the model evaluation system 200 or to an outside system which causes the images to be stored in database 204. For example, objects may be labeled in the images optionally along with location information. The images may then be used by the system 200, for example to generate output (e.g., raw output 222) as described above.

### Other Embodiments

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and engines described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A method implemented by a system of one or more processors, the method comprising:
obtaining information associated with a machine learning (ML) model, wherein the ML model is associated with autonomous or semi-autonomous operation of a vehicle;
obtaining validation data, wherein the validation data includes one or more video sequences obtained from image sensors of an end-user vehicle;
obtaining output via computing forward pass-through ML model using validation data, wherein the output indicates, at least, location information associated with objects detected via the ML model in the validation data;
determining values associated with metrics based on the obtained output; and
generating user interface information based on one or more of the determined values or obtained output.

2. The method of claim 1, wherein the validation data further includes one or more of velocities of the end-user vehicle.

3. The method of claim 1, wherein the user interface information includes a graphical representation of objects detected via the ML model.

4. The method of claim 3, wherein the user interface information further includes error information associated with the objects.

5. The method of claim 1, wherein the user interface:
presents a graphical depiction of the end-user vehicle;
presents ground truth locations of the objects which are proximate to the end-user vehicle; and
adjusts individual presentations of the ground truth locations to reflect individual errors associated with the location information indicated in the output.

6. The method of claim 5, wherein each adjusted presentation includes a color whose radius is selected based on the error.

7. The method of claim 5, wherein the user interface presents a particular video sequence and wherein the ground truth locations of the objects are updated based on the video sequence.

8. The method of claim 7, wherein the individual presentations of the ground truth locations are updated based on the video sequence.

9. A system comprising one or more processors and computer storage media storing instructions that when executed by the one or more processors, cause the one or more processors to perform operations comprising:
obtaining information associated with a machine learning (ML) model, wherein the ML model is associated with autonomous or semi-autonomous operation of a vehicle;
obtaining validation data, wherein the validation data includes one or more video sequences obtained from image sensors of an end-user vehicle;
obtaining output via computing forward pass-through ML model using validation data, wherein the output indicates, at least, location information associated with objects detected via the ML model in the validation data;
determining values associated with metrics based on the obtained output; and
generating user interface information based on one or more of the determined values or obtained output.

10. The system of claim 9, wherein the validation data further includes one or more of velocities of the end-user vehicle.

11. The system of claim 9, wherein the user interface information includes a graphical representation of objects detected via the ML model.

12. The system of claim 11, wherein the user interface information further includes error information associated with the objects.

13. The system of claim 9, wherein the user interface:
presents a graphical depiction of the end-user vehicle;
presents ground truth locations of the objects which are proximate to the end-user vehicle; and
adjusts individual presentations of the ground truth locations to reflect individual errors associated with the location information indicated in the output.

14. The system of claim 13, wherein each adjusted presentation includes a color whose radius is selected based on the error.

15. The system of claim 13, wherein the user interface presents a particular video sequence and wherein the ground truth locations of the objects are updated based on the video sequence.

16. The system of claim 15, wherein the individual presentations of the ground truth locations are updated based on the video sequence.

17. Non-transitory computer storage media storing instructions that when executed by a system of one or more computers, cause the computers to perform operations comprising:

18. The computer storage media of claim 17, wherein the user interface:
presents a graphical depiction of the end-user vehicle;
presents ground truth locations of the objects which are proximate to the end-user vehicle; and
adjusts individual presentations of the ground truth locations to reflect individual errors associated with the location information indicated in the output.

19. The computer storage media of claim 18, wherein each adjusted presentation includes a color whose radius is selected based on the error.

20. The computer storage media of claim 18, wherein the user interface presents a particular video sequence and wherein the ground truth locations of the objects are updated based on the video sequence.

21. The computer storage media of claim 20, wherein the individual presentations of the ground truth locations are updated based on the video sequence.
